(19) United States
(12) Patent Application Publication
(10) Pub. No.: US 2026/0243867 A1
(43) Pub. Date: Aug. 20, 2026

(54) RADAR APPARATUS AND METHOD FOR OPERATING A RADAR APPARATUS

(71) Applicant: Robert Bosch GmbH, Stuttgart (DE)

(72) Inventors: Alexander Onic, Österreich (AT); Andrej Sagainov, Leonberg (DE); Dirk Steinbuch, Wimsheim (DE); Markus Gonser, Albstadt-Laufen (DE); Michael Ott, Leonberg (DE); Rainer Stuhlberger, Österreich (AT)

(21) Appl. No.: 19/480,388

(22) PCT Filed: Apr. 18, 2024
(86) PCT No.: PCT/EP2024/060507

§ 371 Date: Oct. 31, 2025

(30) Foreign Application Priority Data
May 3, 2023 (DE) 10 2023 204 056.5

(51) Int. Cl. G01S 7/40

(52) U.S. Cl. CPC G01S 7/40

(57) ABSTRACT

A radar apparatus. The radar apparatus includes: a local oscillator configured to generate a continuous wave or modulated continuous wave local oscillator signal; a test signal generator configured to generate a test signal and modulate it onto a signal derived from the local oscillator signal to generate a feedback signal; a transmitting device configured to emit a radar signal based on the local oscillator signal; a receiver device that is configured to receive the reflected radar signal, generate a receive signal, and feed back the feedback signal with the receive signal to generate an output signal; and an evaluation device configured to ascertain at least one characteristic value of the radar apparatus using the output signal. A frequency range of the test signal lies outside a frequency range intended for applications of the radar apparatus.

### FIELD

The present invention relates to a radar apparatus and a method for operating a radar apparatus.

### BACKGROUND INFORMATION

Radar apparatuses can be used to identify distances, relative speeds and angular ranges of objects in the surroundings of a motor vehicle. A method for acquiring objects or radar markers is described in Germany Patent Application No. DE 10 2018 126 158 A1.

For safety-critical applications in particular, it is important that the radar apparatuses are operated without errors or that errors are at least detected early.

Ice or snow cover or temperature effects can cause drift, for example; i.e., the amplitudes or phases of individual antenna elements shift relative to one another.

Therefore, in radar apparatuses, some characteristic parameters can be monitored with respect to functional safety or performance. This usually does not take place during radar operation, i.e., in the modulation phase when data for the application is being measured, but rather during a special monitoring phase in which no application data are being acquired.

During the monitoring phase, an internally generated test signal can be modulated onto a transmission signal, or a special test signal that is fed directly into the receive chain to observe the effects of random hardware errors on the measured receiver output can be provided.

### SUMMARY

The present invention provides a radar apparatus and a method for operating a radar apparatus.

Preferred embodiments of the present invention are disclosed herein.

According to a first aspect, the present invention relates to a radar apparatus. According to an example embodiment of the present invention, the radar apparatus comprises a local oscillator that is configured to generate a continuous wave (CW) or modulated continuous wave (FMCW) local oscillator signal. The radar apparatus further comprises a test signal generator that is configured to generate a test signal and modulate it onto a signal derived from the local oscillator signal to generate a feedback signal. The radar apparatus further comprises a transmitting device that is configured to emit a radar signal based on the local oscillator signal. The radar apparatus further comprises a receiver device that is configured to receive the reflected radar signal, generate a receive signal and feed back the feedback signal with the receive signal to generate an output signal. The radar apparatus also comprises an evaluation device that is configured to ascertain at least one characteristic value of the radar apparatus using the output signal. A frequency range of the test signal lies outside a frequency range intended for applications of the radar apparatus.

According to a second aspect, the present invention relates to a method for operating a radar apparatus. According to an example embodiment of the present invention, a continuous wave (CW) or modulated continuous wave (FMCW) local oscillator signal is generated by a local oscillator of the radar apparatus. A test signal generator of the radar apparatus generates a test signal and modulates the test signal onto a signal derived from the local oscillator signal to generate a feedback signal. A transmitting device of the radar apparatus emits a radar signal based on the local oscillator signal. A receiver device of the radar apparatus receives the reflected radar signal, generates a receive signal and feeds back the feedback signal with the receive signal to generate an output signal. An evaluation device of the radar apparatus ascertains at least one characteristic value of the radar apparatus using the output signal. A frequency range of the test signal lies outside a frequency range intended for applications of the radar apparatus.

Because the frequency range of the test signal lies outside a frequency range intended for applications of the radar apparatus, the application is not impaired; i.e., no impairments occur during the modulation phase. This allows the monitoring of the radar apparatus on the basis of the test signal to be carried out independently of the application.

According to one example embodiment of the radar apparatus of the present invention, the characteristic value of the radar apparatus comprises at least one of a gain of the receiver device, a filter characteristic of the receiver device, a relative amplitude drift of the receiver device (i.e., of receiving antennas relative to one another), a relative phase drift of the receiver device, a power of the transmitting device, a relative power drift of the transmitting device (i.e., of transmitting antennas relative to one another), a phase setting of the transmitting device and a relative phase drift of the transmitting device.

According to one example embodiment of the radar apparatus of the present invention, the test signal comprises a fundamental oscillation or a fundamental oscillation and at least one harmonic. The test signal can be a square wave signal, for example.

According to one example embodiment of the radar apparatus of the present invention, the evaluation device is configured to ascertain at least one first characteristic value of the radar apparatus using the fundamental oscillation and ascertain at least one second characteristic value of the radar apparatus using the harmonic. Harmonics can thus be used to monitor the radar apparatus. A variety of properties can be monitored in parallel. The receiver device can be monitored at multiple frequency points for correct passband gain and stop band attenuation, for instance.

According to one example embodiment of the radar apparatus of the present invention, the receiver device is configured to generate the output signal while the radar apparatus is being operated for an application. An additional monitoring phase can thus be shortened or even eliminated entirely. This increases the time available for applications.

According to one example embodiment of the radar apparatus of the present invention, the evaluation device is configured to ascertain the at least one characteristic value of the radar apparatus while the radar apparatus is being operated for an application. The test phase can thus take place parallel to the modulation phase (application).

According to one example embodiment of the present invention, the radar apparatus comprises a memory device that is configured to store the output signal, wherein the evaluation device is configured to ascertain the at least one characteristic value of the radar apparatus after the radar apparatus has ended the application. The evaluation can thus be carried out in series while the feedback signal is fed back in parallel to the modulation phase.

According to one example embodiment of the radar apparatus of the present invention, the evaluation device is configured to ascertain spectral properties of the output signal to ascertain the at least one characteristic value of the radar apparatus.

According to one example embodiment of the radar apparatus of the present invention, the evaluation device is configured to compare the ascertained spectral properties of the output signal with predetermined values to ascertain the at least one characteristic value of the radar apparatus. An error can in particular be detected if certain threshold values are exceeded.

Further advantages, features, and details of the present invention will emerge from the following description, in which different embodiment examples of the present invention are described in detail with reference to the figures.

### BRIEF DESCRIPTION OF THE DRAWINGS

FIG. 1 shows a schematic block diagram of a radar apparatus according to an example embodiment of the present invention.

FIG. 2 shows a schematic circuit diagram of a radar apparatus according to another example embodiment of the present invention.

FIG. 3 shows a schematic flow chart of a method for operating a radar apparatus according to an example embodiment of the present invention.

In all figures, identical or functionally identical elements and devices are provided with the same reference sign. The numbering of method steps is for the sake of clarity and is generally not intended to imply a specific chronological order. It is in particular also possible to carry out multiple method steps at the same time.

### DETAILED DESCRIPTION OF EXAMPLE EMBODIMENTS

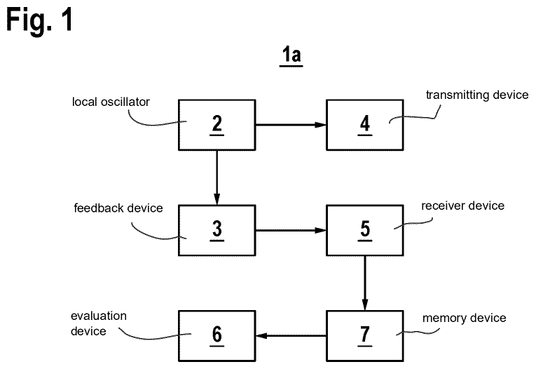

FIG. 1 shows a schematic block diagram of a radar apparatus 1a. The radar apparatus 1a comprises a local oscillator 2 which generates a local oscillator signal. The radar apparatus 1a can in particular be provided for a motor vehicle.

The radar apparatus 1a further comprises a feedback device 3 which generates a test signal. The test signal can be a pure signal, i.e., having only a single frequency (fundamental oscillation). However, the test signal can also include a fundamental oscillation and at least one harmonic, i.e., a non-pure signal.

The feedback device 3 modulates the test signal onto a signal derived from the local oscillator signal, thereby generating a feedback signal. The derived signal can be the local oscillator signal itself. The derived signal can be branched off before or also after a phase-locked loop of a transmitting device 4 of radar apparatus 1a.

The transmitting device 4 emits a radar signal based on the local oscillator signal. The transmitting device 4 can comprise a variety of antenna elements, such as patch antennas, for this purpose. The radar signal can be generated using a conventional method, such as a continuous wave (CW) radar method or using frequency modulation (e.g., frequency modulated continuous wave (FMCW)).

The radar signal is reflected by radar targets in the surroundings of the radar apparatus 1. The radar apparatus 1a further comprises a receiver device 5 which receives the reflected radar signal and generates a receive signal.

The feedback signal is fed back with the received signal in the receiver device 5 to generate an output signal. The feedback signal can be modulated onto the receive signal, for example, i.e., added to the receive signal, to generate the output signal.

The radar apparatus comprises a memory device 7, in particular a volatile or non-volatile memory, for storing the output signal.

The radar apparatus 1a further comprises an evaluation device 6 which ascertains at least one characteristic value of the radar apparatus 1a using the output signal stored in the memory device 7.

The characteristic value of the radar apparatus can be a gain of the receiver device 5, a filter characteristic of the receiver device 5, a relative amplitude drift of the receiver device 5, a relative phase drift of the receiver device 5, a power (gain) of the transmitting device 4, a relative power drift of the transmitting device 4, a phase setting of the transmitting device 4, and/or a relative phase drift of the transmitting device 4.

The evaluation device 6 can ascertain spectral properties of the output signal in order to ascertain the at least one characteristic value of the radar apparatus 1a. For this purpose, the evaluation device 6 can in particular perform a Fourier transformation.

According to one example embodiment of the radar apparatus 1a, the evaluation device 6 is configured to compare the ascertained spectral properties of the output signal with predetermined values to ascertain the at least one characteristic value of the radar apparatus 1a.

A frequency range of the test signal lies outside a frequency range intended for applications of the radar apparatus. If the frequency range for the radar apparatuses is in the range up to 40 MHz, for example, the frequency range of the test signal is above 40 MHZ.

When using a non-pure test signal, the evaluation device 6 can ascertain at least one first characteristic value of the radar apparatus 1a using the fundamental oscillation, and ascertain at least one second characteristic value of the radar apparatus 1a using the harmonic. The evaluation device 6 can appropriately filter the output signal with a filter in order to evaluate the relevant frequency contributions.

It can be provided that the receiver device 5 generates the output signal while the radar apparatus 1a is being operated for an application. The evaluation device 6 can also ascertain the at least one characteristic value of the radar apparatus while the radar apparatus is being operated for an application.

However, the evaluation device 6 can also ascertain the at least one characteristic value of the radar apparatus only after the radar apparatus 1a has ended the application.

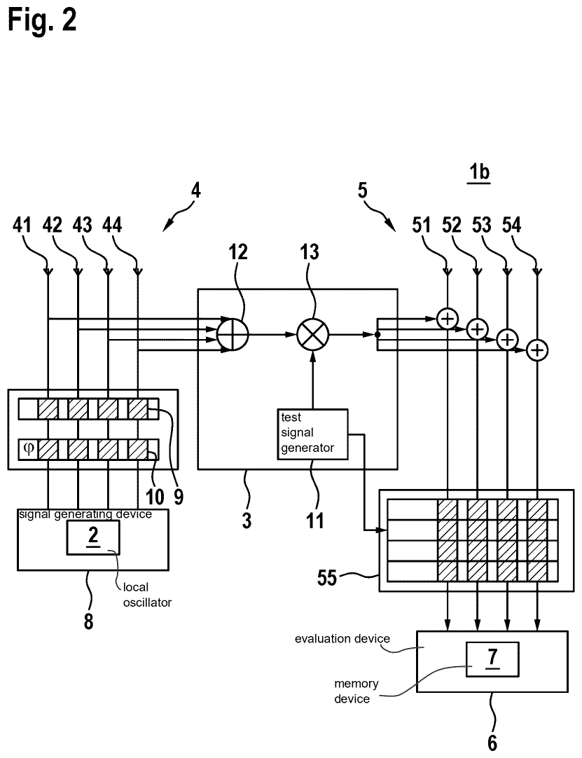

FIG. 2 shows a schematic circuit diagram of a radar apparatus 1b. The components described in the following can be configured as in the radar apparatus 1a shown in FIG. 1, therefore details are not repeated here.

A signal generating device 8 comprising a local oscillator 2 generates a radar signal that depends on a local oscillator signal of the local oscillator 2.

The radar signal is processed by means of a phase shifter 10 and a power amplifier 9 before being emitted by four antenna elements 41 to 44 of a transmitting device 4. The transmitting device 4 can also have a different number of the antenna elements 41 to 44.

The feedback device 3 generates a feedback signal, wherein a test signal generator 11 of the feedback device 3 generates a test signal and modulates it onto a signal derived from the local oscillator signal of the local oscillator 2. For this purpose, the radar signals of the antenna elements 41 to 44, which are derived from the local oscillator signal, can be added by an adder 12 and mixed with the test signal by a mixer 13. The test signal can also be modulated directly onto the local oscillator signal.

The receiver device 5 comprises four antenna elements 51 to 54 and the feedback signal can be added to the respective receive signals.

The receive signals are first further processed in components 55 of the receiver device 5 and then further evaluated by an evaluation device 6 with a memory device 7 as described above.

A frequency range of the test signal lies outside a frequency range intended for applications of the radar apparatus 1b. For example, if decimation chains for output rates of 40, 20, 10 or 5 MHz are provided for the application of the radar apparatus 1b, the frequency range of the test signal can be between 40 and 80 MHZ.

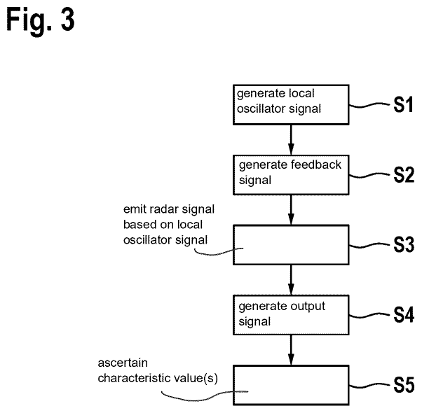

FIG. 3 shows a schematic flow chart of a method for operating a radar apparatus, in particular one of the above-described radar apparatuses 1a; 1b.

In a first method step S1, a local oscillator signal is generated by a local oscillator 2 of the radar apparatus 1a, 1b.

A feedback device 3 of the radar apparatus 1a, 1b generates a test signal and modulates the test signal onto a signal derived from the local oscillator signal to generate a feedback signal, S2.

In a method step S3, a transmitting device 4 of the radar apparatus 1a, 1b emits a radar signal based on the local oscillator signal.

In a method step S4, a receiver device 5 of the radar apparatus 1a, 1b receives the reflected radar signal, generates a receive signal and feeds back the feedback signal with the receive signal (for example, by adding the signals) to generate an output signal.

In a method step S5, an evaluation device 6 of the radar apparatus 1a, 1b ascertains at least one characteristic value of the radar apparatus using the output signal, S5. A frequency range of the test signal lies outside a frequency range intended for applications of the radar apparatus 1a; 1b.

1-10. (canceled)

11. A radar apparatus, comprising:
a local oscillator configured to generate a continuous wave or modulated continuous wave local oscillator signal;
a feedback device configured to generate a test signal and modulate the test signal onto a signal derived from the local oscillator signal to generate a feedback signal;
a transmitting device configured to emit a radar signal based on the local oscillator signal;
a receiver device configured to receive a reflected radar signal, generate a receive signal, and feed back the feedback signal with the receive signal to generate an output signal; and
an evaluation device configured to ascertain at least one characteristic value of the radar apparatus using the output signal;
wherein a frequency range of the test signal lies outside a frequency range intended for applications of the radar apparatus.

12. The radar apparatus according to claim 11, wherein the characteristic value of the radar apparatus includes at least one of: a gain of the receiver device, a filter characteristic of the receiver device, a relative amplitude drift of the receiver device a relative phase drift of the receiver device, a power of the transmitting device, a relative power drift of the transmitting device, a phase setting of the transmitting device, a relative phase drift of the transmitting device.

13. The radar apparatus according to claim 11, wherein the test signal includes: (i) a fundamental oscillation, or (ii) a fundamental oscillation and at least one harmonic.

14. The radar apparatus according to claim 13, wherein the evaluation device is configured to ascertain at least one first characteristic value of the radar apparatus using the fundamental oscillation and ascertain at least one second characteristic value of the radar apparatus using the harmonic.

15. The radar apparatus according to claim 11, wherein the receiver device is configured to generate the output signal while the radar apparatus is being operated for an application.

16. The radar apparatus according to claim 15, wherein the evaluation device is configured to ascertain the at least one characteristic value of the radar apparatus while the radar apparatus is being operated for the application.

17. The radar apparatus according to claim 15, further comprising a memory device configured to store the output signal, wherein the evaluation device is configured to ascertain the at least one characteristic value of the radar apparatus after the radar apparatus has ended the application.

18. The radar apparatus according to claim 11, wherein the evaluation device is configured to ascertain spectral properties of the output signal to ascertain the at least one characteristic value of the radar apparatus.

19. The radar apparatus according to claim 18, wherein the evaluation device is configured to compare the ascertained spectral properties of the output signal with predetermined values to ascertain the at least one characteristic value of the radar apparatus.

20. A method for operating a radar apparatus, comprising the following steps:
generating a continuous wave or modulated continuous wave local oscillator signal using a local oscillator of the radar apparatus;
generating a test signal and modulating the test signal onto a signal derived from the local oscillator signal to generate a feedback signal using a feedback device of the radar apparatus;
emitting a radar signal based on the local oscillator signal using a transmitting device of the radar apparatus;
receiving a reflected radar signal, generating a receive signal, and feeding back the feedback signal with the receive signal to generate an output signal using a receiver device of the radar apparatus; and
ascertaining at least one characteristic value of the radar apparatus using the output signal by an evaluation device of the radar apparatus;
wherein a frequency range of the test signal lies outside a frequency range intended for applications of the radar apparatus.
